(19) United States
(12) Patent Application Publication
(10) Pub. No.: US 2007/0283581 A1
(43) Pub. Date: Dec. 13, 2007

(54) Safe Shaving Implement for Prisoners Using Non-reformable Materials

(75) Inventors: Paul J. Biermann, Columbia, MD (US); Gary E. Peck, Baltimore, MD (US)

Correspondence Address: THE JOHNS HOPKINS UNIVERSITYAPPLIED PHYSICS LABORA;OFFICE OF PATENT COUNSEL, 11100 JOHNS HOPKINS ROAD, MAIL STOP 7-156, LAUREL, MD, 20723-6099, US

(73) Assignee: The Johns Hopkins University, Baltimore, MD (US)

(21) Appl. No.: 11/756,992

(22) Filed: Jun. 1, 2007

Related U.S. Application Data
(60) Provisional application No. 60/809,880, filed on Jun. 1, 2006.

(51) Int. Cl. B26B 21/52

(52) U.S. Cl. 30/526; 29/428

(57) ABSTRACT

A shaving implement includes a handle fabricated from a soft, flexible and non-meltable material incapable of taking an edge or a point capable of penetrating human skin, and a frangible razor blade.

### CROSS REFERENCE TO RELATED APPLICATIONS

This application claims the benefit of prior filed, co-pending U.S. provisional application Ser. No. 60/809,880, filed on Jun. 1, 2006, which is incorporated herein by reference in its entirety.

### STATEMENT OF GOVERNMENTAL INTEREST

This invention was made with Government support under National Institute of Justice contract number 2002-I-J-CX-K017. The Government has certain rights in the invention.

### BACKGROUND OF THE INVENTION

1. Field of the Invention

The present invention generally relates to handheld implements such as articles for personal hygiene, e.g., toiletry articles, communication and eating. More particularly, the present invention is directed to hand-held implements formed from nonsharpenable and non-meltable materials for use by prison inmates.

2. Description of the Related Art

Hand-held articles such as, for example, toothbrushes, safety razors, writing implements, eating utensils and the like, can be modified by an individual so as to be reformed into weapons. For example, the plastic body can produce a pointed or edged weapon. Eating utensils such as plastic knives, forks or spoons can also be modified to produce weapons.

This creates a potentially dangerous situation when, for example, a prison inmate reforms a hand-held article into a weapon for use against prison guards or other inmates. Consequently, it would be advantageous to have a hand-held article which can be used by the inmates without the danger of being reformed into a weapon.

U.S. Publication No. 2003/0223802A1, which is herein incorporated by reference in its entirety, discloses implements which are not capable of being reformed into a weapon. The implements comprise a body having a proximal handle portion and a distal operational portion, the body being nonsharpenable and fabricated from a non-meltable material and having frangible means for limiting body strength by facilitating structural failure of the body upon application thereto of a force exceeding a predetermined magnitude. The implement can advantageously be used, for example, in prison environments to prevent injury to the correctional facility staff and inmates caused by the unauthorized fabrication of weapons from commonly used implements and utensils.

Safety razors are of particulars concern because of the presence of an extremely sharp, cutting blade. The blade can be extracted and attached to a slot in a plastic handle to produce a dangerous edged or pointed weapon. What is needed is a safety razor which cannot easily be modified to produce a weapon.

### BRIEF DESCRIPTION OF THE DRAWINGS

Various embodiments of the invention are described below with reference to the drawings wherein:

FIG. 1 is a partially sectional exploded view of a safety razor of the invention;

FIG. 2 is a perspective view of a razor blade for use in the safety razor; and

FIG. 3 is a perspective view illustrating another embodiment of the safety razor.

### SUMMARY

A safe shaving implement is provided herein which includes a handle portion fabricated from a non-meltable material with sufficient softness and flexibility to prevent said material from being able to take an edge or a point capable of penetrating human skin, and a head portion having a frangible razor blade fixedly mounted thereto.

### DETAILED DESCRIPTION OF PREFERRED EMBODIMENT(S)

It will be understood that any numerical range recited herein is intended to include all subranges within the recited range.

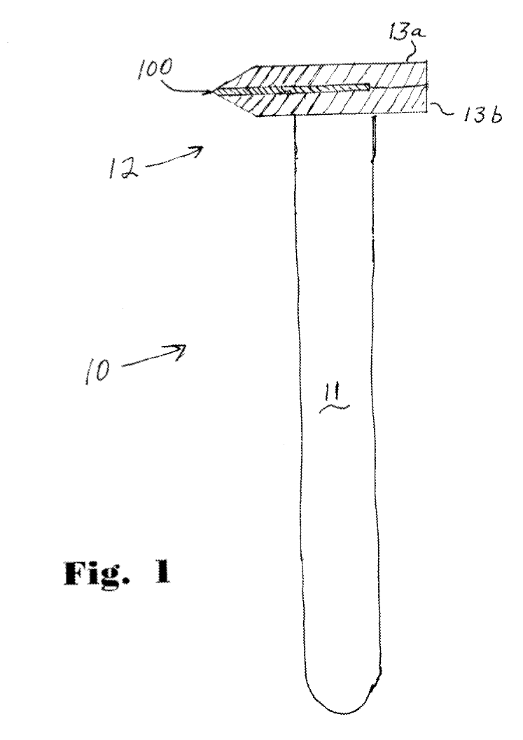

Referring now to FIG. 1, a safety razor 10 includes an elongated proximal handle 11, and a head portion 12 preferably permanently mounted to the handle 11 and containing one or more razor blades.

The handle 11 is preferably fabricated from a non-meltable material such as a thermoset resin, optionally fabricated with a plasticizer so as to provide a soft handle 11 having sufficient flexibility to prevent the handle 11 from being modified to take cutting edge or to be pointed so as to be useful as a weapon. Suitable thermoset materials include, but are not limited to, thermoset polymeric resins such as, for example, epoxy resins, melamine resin, phenolic resins, urea-formaldehyde resins, phenolformaldehyde resins (e.g., Bakelite®), polyurethanes, polyimides, polyureas, hard or soft rubbers, e.g., butadiene, silicone, or any natural or synthetic elastomer, or virtually any irreversibly cross-linked resin system including allyl resins such as diallyl phthalate and diallyl isophthalate, cyanate ester resins, unsaturated polyesters such as orthophthalic, isophthalic, BPA fumarate and chlorendic resins, bismaleimide, vinyl esters, and combinations of the above, all of which are known and commonly available. Moreover, the handle can be fabricated with an embedded cardboard rod stiffener.

In one embodiment, the head portion 12 is preferably fixedly attached to the handle 11 by conventional means such as adhesive bonding, solvent welding and the like. The head portion 12 is preferably fabricated from a hard non-meltable material such as an unplasticized thermoset resin. Preferably, the entire safety razor 10 is discarded after use without replacement with another head portion 12.

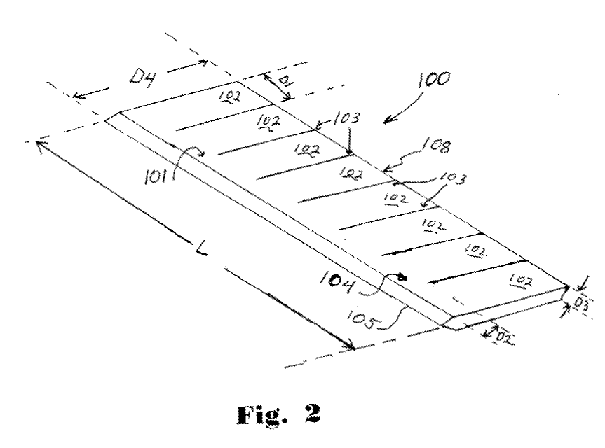

Referring now to FIG. 2, the razor blade 100 is a strip of metal 101 (preferably stainless steel or high carbon steel) having a forward cutting edge 105 and a back edge 108. The metal strip 101 preferably has a thickness D3 ranging from about 0.002 to about 0.005 inches, and a width D4 ranging from about 0.200 inches to about 0.450 inches. The length L can range from about 1.00 inches to about 2.00 inches. A plurality of evenly spaced parallel slots 103 extend from the back edge 108 preferably partially across the razor blade 100 towards the forward cutting edge 105. The slots 103 define panels 102 which are easily separated as explained below. Slots 103 are formed by cuts extending from the top of the razor blade 100 to the bottom as described below. In an embodiment of the invention the only blade metal holding the panels 102 together is a narrow uncut region 104 of the blade extending along the length of the blade between the cutting edge 105 and the ends of the slots 103. The uncut region, if present, preferably has a width D2 of from 0.000 inches up to about 0.040 inches. Optionally, the slots 103 can extend completely across the blade. The panels 102 preferably each have an individual width D1 ranging from about 0.050 inches to about 0.300 inches. It is preferable to have many slots 103 and narrow panels 102 to ensure that no piece which is broken off provides a wide cutting edge. Optionally the razor blade 100 can include apertures to facilitate alignment during the fabrication process.

In one embodiment the head portion 12 comprises two pieces 13a and 13b. The safety razor head portion 12 is preferably fabricated by adhesively bonding the razor blade 100 between the two pieces 13a and 13b. Preferred adhesives for use in the present invention include epoxies, polyurethanes, methacrylates, acrylics and cyanoacrylates, or combinations thereof. The adhesive penetrates the slots 103 thereby individually securing panels 102 to the head portion 12. In the event that the head portion is broken open by an attempt to separate pieces 13a and 13b, the razor blade will fracture, making it difficult to isolate any portion of the razor blade wider than one panel.

Accordingly, the safety razor 10 of the present invention provides significant advantages in that the polymer material of the handle is of sufficient softness and flexibility such that it cannot be used to make a cutting or puncture weapon capable of penetrating human skin.

Moreover, any attempt to remove the razor blade 100 from the head portion 12 will result in the fracture of the blade along the slots 103 into smaller individual panels 102, which significantly reduces the risk of harm if an attempt is made to make a weapon.

In one embodiment the razor blades of the invention can be fabricated by modifying conventional, commercially available razor blades. The preferred method for making slots 103 is by EDM wire cutting. In an embodiment, a plurality of razor blades (e.g., up to 150 blades or more) can be vertically stacked in alignment with each other. The EDM wire can be used to machine slots in the entire stack of razor blades. EDM is a preferred method of cutting the slots, not only for the ease of machining precise cuts in the razor blades, but also because it does not overheat the blade and affect the temper of the blade as would happen, for the example, with laser cutting.

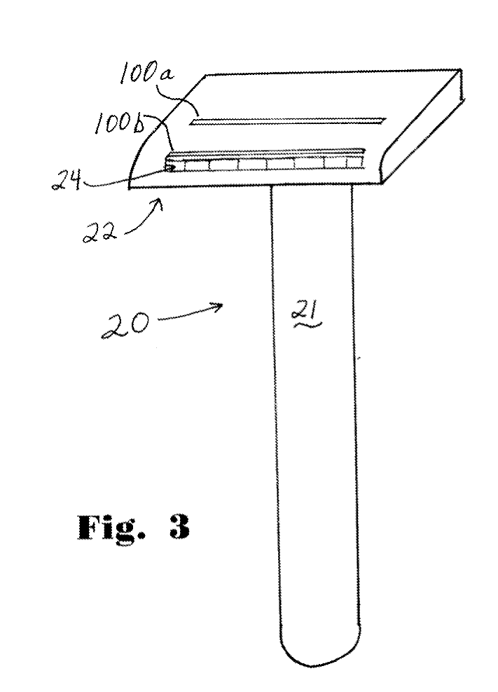

Referring now to FIG. 3, an embodiment 20 of the safety razor is illustrated wherein handle 21 is constructed in a similar fashion to handle 11 described above. Head portion 22 is similar to head portion 12 except that two razor blades 100a and 100b are mounted to head portion 22. A channel 24 is provided to permit the flow though of cut hairs and shaving cream under the blades.

While the above description contains many specifics, these specifics should not be construed as limitations of the invention, but merely as exemplifications of preferred embodiments thereof. Those skilled in the art will envision many other embodiments within the scope and spirit of the invention as defined by the claims appended hereto.

What is claimed is:

1. A shaving implement comprising:
a handle portion fabricated from a non-meltable material with sufficient softness and flexibility to prevent said material from being able to take a sharp edge or point capable of penetrating human skin, and
a head portion having at least one frangible razor blade fixedly mounted thereto.

2. The shaving implement of claim 1 wherein the frangible razor blade comprises a strip of metal having a forward cutting edge and a back edge, a plurality of slots extending from the back edge at least partially across the razor blade towards the cutting edge, said slots extending from a top surface of the razor blade to a bottom surface and at least partially defining a plurality of panel sections.

3. The shaving implement of claim 2 wherein the panel sections are each individually secured to the head portion.

4. The shaving implement of claim 2 wherein the panel sections range in width from about 0.050 inches to about 0.300 inches.

5. The shaving implement of claim 2 wherein the slots are substantially parallel and evenly spaced to each other.

6. The shaving implement of claim 2 wherein the non-meltable material comprises a thermoset resin.

7. The shaving implement of claim 6 wherein the thermoset polymeric material comprises one or more epoxy resins, melamine resins, phenolic resins, urea-formaldehyde resins, phenolformaldehydge resins, polyurethanes, polyimides, polyureas, butadiene polymers, silicone, or any natural or synthetic elastomer, diallyl phthalate, diallyl isophthalate, cyanate ester resins, orthophthalic resins, isophthalic resins, BPA fumarate resins, chlorendic resins, bismaleimide, and/or vinyl esters.

8. The shaving implement of claim 1 wherein the head portion is fabricated from a thermoset polymeric material.

9. The shaving implement of claim 1 wherein the head portion comprises two members with the razor blade adhesively mounted therebetween.

10. The shaving implement of claim 1 wherein the adhesive comprises epoxy, polyurethane, methacylate, acrylic, cyanoacrylate, or combinations thereof.

11. The shaving implement of claim 2 wherein the distance between the cutting edge and forward ends of the slots ranges from about 0.000 inches to about 0.040 inches.

12. A method for making a safety razor comprising:
(a) providing a plurality of razor blades in vertical stacked alignment, each blade having a cutting edge and a back edge;
(b) simultaneously cutting a series of slots in each of the razor blades in the stack by EDM wire cutting, said slots extending from the back edge of the razor blades at least partially across the razor blades towards the respective cutting edges, and extending from a top surface of each blade to a bottom surface of each blade and at least partially defining a plurality of panel sections;
(c) mounting one or more of the razor blades individually to a respective safety razor head portion; and
(d) attaching the head portions individually to a respective handle fabricated from a non-meltable material with sufficient softness and flexibility so as to prevent said material from being able to take a sharp edge or point capable of penetrating human skin.

13. The method of claim 12 wherein in step (b) the slots are evenly spaced and parallel to each other.

14. The method of claim 12 wherein the panels range in width from about 0.050 inches to about 0.300 inches.

15. The method of claim 12 wherein the safety razor head portion comprises two members and wherein step (c) of mounting the razor blades to the safety razor head comprises adhesively bonding each razor blade between the two members of the respective head portion.

16. The method of claim 12 whereas each head portion is fabricated from a non-meltable material.

17. The method of claim 12 wherein non-meltable material is a thermoset resin.

18. The method of claim 17 wherein the thermoset resin comprises one or more of epoxy resins, melamine resins, phenolic resins, urea-formaldehyde resins, phenolformaldehydge resins, polyurethanes, polyimides, polyureas, butadiene polymers, silicone, or any natural or synthetic elastomer, diallyl phthalate, diallyl isophthalate, cyanate ester resins, orthophthalic resins, isophthalic resins, BPA fumarate resins, chlorendic resins, bismaleimide, and/or vinyl esters.

19. The method of claim 12 wherein the head portions are fixedly and non-removably attached to the respective handle portions.

20. The method of claim 19 where the head portions are fabricated from a hard thermoset resin.

21. The method of claim 19 wherein the head portions are adhesively bonded to the respective handle portions.

22. The method of claim 12 wherein the distance between the respective cutting edge of the blades and forward ends of the slots ranges from about 0.000 inches to about 0.040 inches.
